(19) United States
(12) Patent Application Publication
(10) Pub. No.: US 2018/0078088 A1
(43) Pub. Date: Mar. 22, 2018

(54) BAKING APPARATUS

(71) Applicant: Tristar Products, Inc., Fairfield, NJ (US)

(72) Inventors: Keith Mirchandani, Fairfield, NJ (US); Paul McGrath, Flanders, NJ (US); James Mitrik, Long Pond, PA (US)

(21) Appl. No.: 15/694,482

(22) Filed: Sep. 1, 2017

Related U.S. Application Data
(60) Provisional application No. 62/398,359, filed on Sep. 22, 2016.

(51) Int. Cl. A47J 37/01; A47J 36/02; A47J 36/20; A47J 45/06

(52) U.S. Cl. CPC A47J 37/01; A47J 45/06; A47J 36/20; A47J 36/025

(57) ABSTRACT

A baking apparatus has a substantially rectangular baking basket for holding one or more food items supported by a substantially rectangular tray. The tray has a base and a container wall extending upward therefrom and forming an upper lip. The basket has a mesh cradle portion defining a plurality of openings. The mesh cradle portion has a bottom surface and cradle wall extending upwards from the bottom surface and forming, at an upper end, an upper periphery. A solid and continuous support rim is coupled to the upper periphery. Handles extend off the support rim. A series of support members extend from the support rim and hold the basket in a position elevated from the tray. The tray captures discharges from the one or more food items and prevents warping. The tray and basket allow air to circulate substantially freely around the one or more food items.

### CROSS REFERENCE TO RELATED APPLICATION

This application is a U.S. Non-provisional patent application which claims priority from U.S. Provisional application for Patent No. 62/398,359 filed Sep. 22, 2016 and which is incorporated herein by reference.

### BACKGROUND OF THE INVENTION

### 1. Field of the Invention

The subject disclosure relates to cooking apparatus, and more particularly to apparatus for baking food.

### 2. Background of the Related Art

Conventional baking pans, as well as other baking apparatus, are designed such that uncooked food is placed against a solid surface of the pan which in turn is placed over a burner or inside an oven. When the baking pan heats up, the areas of the food that are in contact with the surface of the pan heat up much more quickly than the areas of the food that are exposed to the air, resulting in uneven cooking. Additionally, uneven cooking may spur a user to flip or turn the food one or more times. Furthermore, portions of the food that are in contact with the pan often stick to the pan. At times this can motivate a user to coat the pan in unhealthy non-stick substances, such as butter, oil, or chemicals.

Trying to avoid these problems by cooking certain types of food directly on a mesh apparatus can be difficult, if not impossible. Cooking on a mesh apparatus can result in grease, sauce, and other substances dripping throughout the oven. These substances can be difficult to clean and they also create a risk of causing damage to the oven, which in turn, creates a safety risk for a user.

### SUMMARY

In view of the above, a need exists for a single baking apparatus that allows food to be heated uniformly. Further, it is preferable that the baking apparatus can prevent sticking, without the use of non-stick substances. Finally, it is also preferable that the baking apparatus has a means for preventing the spillage of grease, sauce, cheese, and other substances, throughout an oven.

In one embodiment, the subject technology is directed a baking apparatus having a substantially rectangular baking tray having a base. The base has a container wall extending upward from the base and forming an upper lip. The baking apparatus also has a substantially rectangular basket for holding one or more food items, the basket being supported by the baking tray. The basket has a mesh cradle portion which includes cradle members that define a plurality of openings. The cradle portion includes a bottom surface and a cradle wall extending upwards from the bottom surface. An upper periphery extends around the upper end of the cradle wall.

A solid, continuous support rim is coupled to the upper periphery. A first and second handle are joined to the support rim, at points opposite one another along the support rim. A plurality of support members extend downward from the support rim to a point below the bottom surface of the basket. The support members support the basket in a position elevated from the tray such that the bottom surface is above the upper lip.

In some embodiments, the ratio of the length of the basket to the length of the tray is between 0.91 and 0.96. The ratio of the width of the basket to the width of the tray can be between 0.89 and 0.95. In some embodiments, the mesh cradle openings represent at least 55 percent of the total surface area of the mesh cradle portion.

In some embodiments the tray captures discharges from the one or more food items and prevents warping. The combination of the basket and the tray can allow air to circulate substantially freely around the one or more food items.

It should be appreciated that the subject technology can be implemented and utilized in numerous ways, including without limitation as a process, an apparatus, a system, a device, an assembly, and a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a perspective view of a baking apparatus in accordance with the subject disclosure.

FIG. 2 is an exploded view of a baking apparatus in accordance with the subject disclosure.

FIG. 3 is an overhead view of a baking apparatus in accordance with the subject disclosure.

FIG. 4 is a side view of a baking apparatus in accordance with the subject disclosure.

FIG. 5 is a front view of a baking apparatus in accordance with the subject disclosure.

FIG. 6 is a perspective view of another embodiment of a baking apparatus in accordance with the subject disclosure.

### DETAILED DESCRIPTION OF PREFERRED EMBODIMENTS

The subject technology overcomes many of the prior art problems associated with baking apparatus. The advantages, and other features of the technology disclosed herein, will become more readily apparent to those having ordinary skill in the art from the following detailed description of certain preferred embodiments taken in conjunction with the drawings which set forth representative embodiments of the present technology. It is understood that references to the figures such as up, down, upward, downward, lower, upper, left, and right are with respect to the figures and not meant in a limiting sense. Rather, all words denoting orientation (i.e. up, down) are merely used to describe the positioning of certain components with respect to that of the other components shown and described herein.

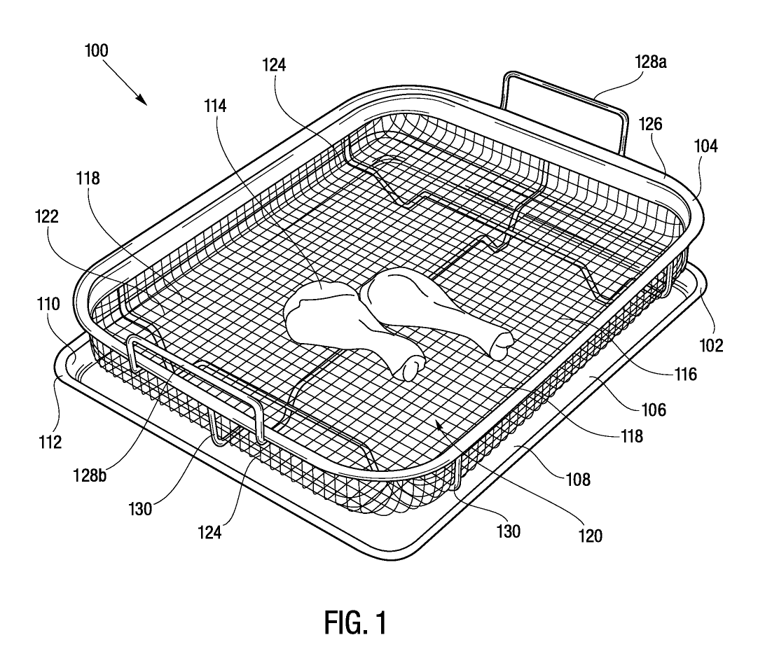

Referring now to FIG. 1, a front view of a baking apparatus 100 is shown. The baking apparatus includes a baking tray 102 and a basket 104. The baking tray 102 is substantially rectangular in shape and has a base 106 which can be placed directly on an oven rack (not shown) while cooking. The upper surface 108 of the base 106 is substantially flat and even resulting in an essentially level surface. A container wall 110 extends upward from the base 108 and forms an upper lip 112, preventing the contents of the tray from dripping throughout an oven.

Seated atop of the baking tray 102 is a substantially rectangular basket 104 for holding one or more food items 114. In general, the basket 104 has a smaller length and width than the baking tray 102. Food items 114 might include, for example, bacon, chicken tenders, mozzarella sticks, or any other food item that can be cooked. The basket 104 has a mesh cradle portion 116, formed by a series of cradle support members 118 which also define a plurality of openings 120. The cradle support members 118 are of a size, with respect to the openings 120, that allows them to provide the structural strength to contain a number of food items 114 while still allowing air to flow around the food items 114 and minimizing the surface contact between the cradle members 118 and the food items 114. The mesh cradle portion 116 includes a bottom surface 122 and a cradle wall 124 which extends upwards from the bottom surface 122, forming, at its upper end, an upper periphery (not shown or labeled distinctly). Notably, the upper periphery simply represents the endpoint of the cradle wall 124. For example, at the upper periphery, the cradle members 118 can be tied together, simply severed at a desired location, or otherwise terminate at an upper end to form a periphery around the upper end of the basket 104.

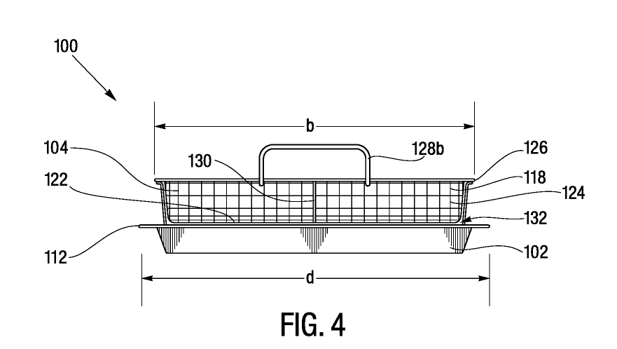

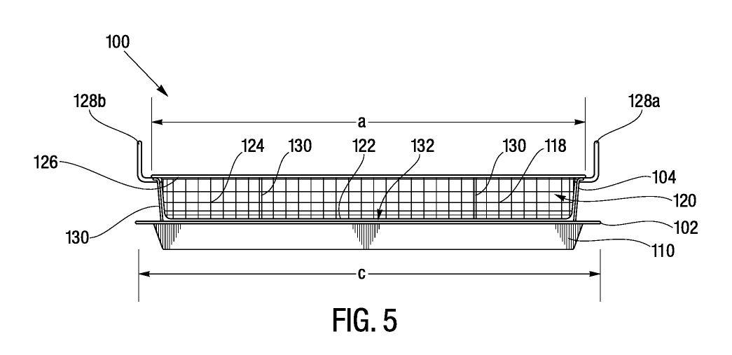

A solid support rim 126 extends around the upper periphery (under the support rim 126), supporting the mesh cradle portion 116 and holding it in a substantially rectangular shape. The support rim 126 also includes handles 128a, 128b, positioned opposite one another along the support rim 126 to facilitate easy gripping of the basket 104. A series of support members 130 extend from the support rim 126. When the basket 104 is placed upon the tray 102, the support members 130 contact the tray 102 at a point below the bottom surface 122. In this way, the support members 130 hold the basket 104 in a position elevated from the tray 102 to increase airflow underneath the bottom surface 122 (as seen best in FIGS. 4-5). The support members 130 are designed to retain the basket 104 in this elevated position while not impeding air flow around the food items 114.

All components of the tray 102 and basket 104 can be formed by applying a non-stick coating material to an underlying structural material. The underlying structural material may be, for example, aluminum, stainless steel, or any other material that provides sufficient support for the baking apparatus 100 to retain its form. The non-stick coating material can be formed by applying, for example, a ceramic material or ceramic polish to the structural material. One skilled in the art would recognize that the subject disclosure is not limited the above examples and variety of other materials could be used as a non-stick coating and/or structural material.

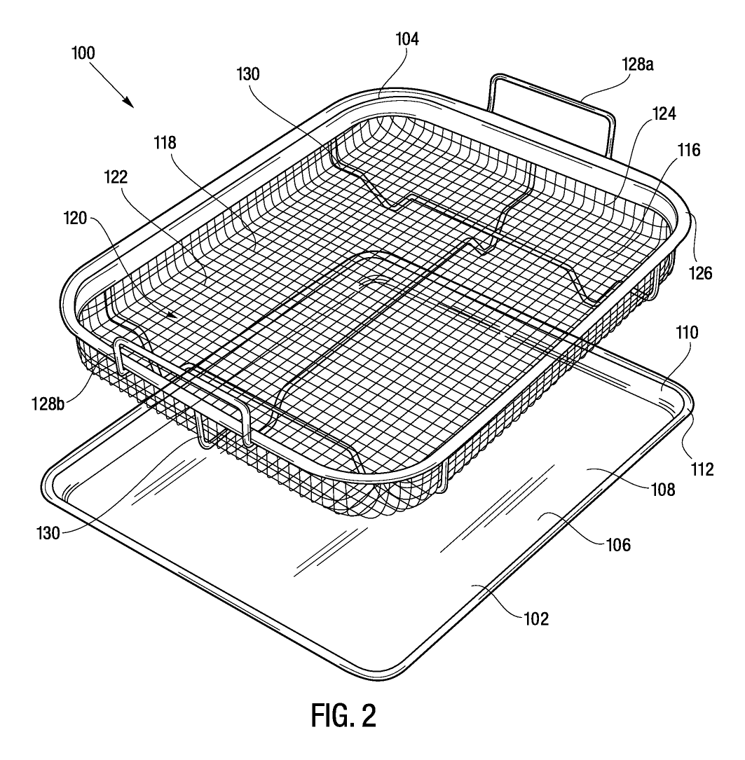

Referring now to FIG. 2, an exploded view of a baking apparatus in accordance with the subject technology is shown. In normal use, the user may separate the tray 102 from the basket 104. This allows for more convenient washing and storage of the baking apparatus 100.

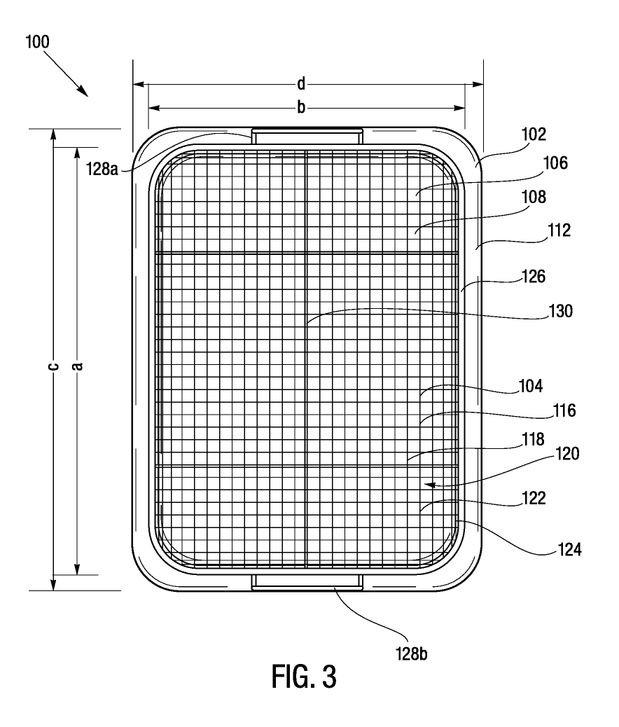

Referring now to FIGS. 3-5, an overhead view, side view, and front view of a baking apparatus in accordance with the subject technology are shown. The basket 104 is shown resting atop the tray 102, in accordance with an embodiment of the subject technology. The basket 104 has a substantially rectangular shape, having a length “a” and a width “b”. The tray 102 also has a substantially rectangular shape, and has a length “c” and a width “d”. The overall size of the basket 104 and tray 102 may vary depending on the preferences of the user and the food they desire to bake.

Certain proportions between the basket 104 and tray 102 have proven to be effective in promoting the objects of the subject disclosure. A ratio of basket 104 length “a” to tray length “c” of between 0.91 and 0.96 has been found to be effective, while a ratio of basket 104 width “b” to tray 102 width “d” of between 0.89 and 0.95 has been found to be effective. Various effective sizes in accordance with these ratios are shown in Table 1 below. These ratios and sizes are meant merely to be demonstrative of effective proportions and one skilled in the art would recognize that other sizes of basket 104 and tray 102 may be effective for accomplishing the goals of the subject disclosure. For example, the below sizes may be increased or decreased by approximately 5 mm and still be relatively effective.

TABLE 1

| Basket | Basket | Tray | Tray |
|---|---|---|---|
| Length “a” | Width “b” | Length “c” | Width “d” |
| 303 mm | 223 mm | 325 mm | 245 mm |
| 328 mm | 278 mm | 350 mm | 300 mm |
| 355 mm | 303 mm | 375 mm | 325 mm |

The proportions between the cradle members 118 and openings of the mesh cradle portion 116 both adequately support any food contained thereon and prevent warping of the baking apparatus 100. This can be accomplished with a mesh cradle portion 116 having an area that is made up of mostly openings 120 with a limited amount of area occupied by cradle members 118. The openings 120 can take up an area of between 55%-95% of the total area of the mesh cradle portion 116. In one embodiment, the openings 120 occupy approximately 76% of the mesh cradle portion 116. This can be accomplished, for example, by utilizing cradle members 118 with a diameter (or width) of approximately 0.76 mm. The mesh cradle portion 116 can have a bottom surface 122 that is, for example, approximately 282.5 mm in length and 199 mm in width, and includes approximately 32 wires running lengthwise and 44 wires running widthwise. This will result in approximately 76% of the mesh cradle portion 116 being openings 120, while cradle members 118 represent approximately 24% of the mesh cradle portion 116.

Referring now to FIGS. 4-5, the support members 130 support the basket 104 in a position elevated from the tray 102 such that there is a gap 132 between the upper lip 112 of the tray 102 and the bottom surface 122. The gap 132 works to accomplish the goals of the subject disclosure by allowing air flow underneath any food items in the basket 104.

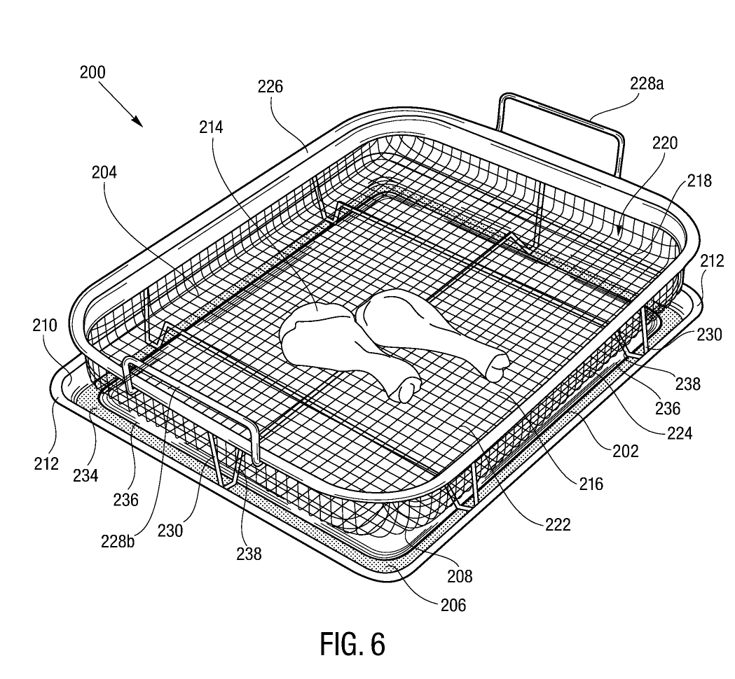

Referring now to FIG. 6, a perspective view of another embodiment of the baking apparatus of the subject disclosure is shown generally at 200. The baking apparatus 200 is similar to the baking apparatus 100 described above with several unique features discussed below. Accordingly, reference numerals preceded by the number “2” instead of the numeral “1” are used to indicate like elements. In this embodiment, the gap 132 (seen in FIGS. 4-5) may or may not be included. Removal of the gap 132 can result in a more stable baking apparatus 200 as there is less space between the basket 204 and the tray 202. Alternatively, inclusion of the gap 132 can allow increased air flow around the food items 214.

The baking apparatus 200 includes a tray 202 which has a channel 234 running proximate to the container walls 210, between the container walls 210 and an elevated base surface 208. A ramp 236 connects the channel 234 with an elevated base surface 208 which forms a flat portion of the base 206. When substances drip from the food items 214 onto the tray 202, they can pool in the channel 234 to make for easier cleanup. Further, the support members 230 of the basket 204 are spaced such that they contact the base 206 within the channel portion 234. Alternatively, or additionally, the support members 230 may contact the ramp 236, and the support members 230 may have angled support legs 238 which rest along the ramp 236 to provide additionally stability between the basket 204 and tray 202. Similarly, the support members 230 may rest against the container walls 210 alternative or in addition to resting against any of the other portions of the tray 202 as described above. By positioning the support members 230 and the support legs 238 in the channel 234, along the ramp 236, and/or against the container walls 210, the basket 204 resists sliding with respect to the tray 202 when the baking apparatus 200 is handled.

Referring again to FIG. 1, in a preferred embodiment food items 114 are placed within the basket 104, which rests atop the tray 102. The entire baking apparatus 100 is then placed within an oven (not shown). As the food items 114 bake, the openings 120 in the basket 104 allow heated air to flow around the food items 114. This is further effectuated by the relatively smaller size of the basket 104 as compared to the tray 102. Additionally, the elevation of the bottom surface 122 of the basket 104 above the upper lip 112 of the tray 102 allows increased air flow underneath the food items 114.

While food items 114 are baking, the openings 120 in the mesh cradle portion 116 create a limited contact surface between the mesh cradle portion 116 and the food items 114 which reduces sticking. Minimal sticking allows the user to cook the food items 114 without the need to coat the baking apparatus 100 with unhealthy non-stick substances, such as butter, oil, or chemicals. Further, the combination of limited contact and increased air flow around the food items 114 allows the food items 114 to cook thoroughly and evenly without requiring flipping or turning.

Still referring to FIG. 1, in the embodiment shown, the tray 102 is stationed underneath the basket 104 while baking. In this position, the tray 102 collects drippings from the food items 114, such as grease, sauce, or cheese, for example. By preventing substances from falling into the oven (not shown), the user avoids having a dirty, damaged, or even potentially dangerous oven. The positioning of the tray 102 underneath the basket 104 also helps reduce direct heat from a lower heat source in an oven to the mesh cradle portion 116, preventing warping of the mesh cradle portion 116.

Referring now to FIG. 6, in some embodiments, the tray 202 includes channels 234 which collect substances dripping off the food items 214, and interact with the basket support members 230 to keep the baking apparatus 200 stable.

Referring back to FIG. 1, while the basket 104 and tray 102 support one another when baking, they are also separable. This allows for easier handling of the baking apparatus 100 and makes washing and storing the baking apparatus 100 easier.

It is envisioned that many modifications to the subject technology are possible. For example, the tray 102 and basket 104 could be used individually to cook food rather than in conjunction with one another. It would be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., assemblies, coupling parts and the like) shown as distinct for purposes of illustration may be incorporated within other functional elements in a particular implementation. With respect to the claims, any or all of the claims may be rearranged to depend from any or all of the other claims in any arrangement.

While the subject technology has been described with respect to preferred embodiments, those skilled in the art will readily appreciate that various changes and/or modifications can be made to the subject technology without departing from the spirit or scope of the invention as defined by the appended claims.

1. A baking apparatus comprising:
a tray having a base and a container wall extending upward from the base and forming an upper lip; and
a basket for holding one or more food items, the basket being supported by the tray and having:
a mesh cradle portion having cradle members which define a plurality of openings, said mesh cradle portion having a bottom surface and a cradle wall extending upwards from the bottom surface, the cradle wall forming, at an upper end, an upper periphery; and
a plurality of support members coupled to the basket and extending below the bottom surface of the mesh cradle portion, the support members supporting the basket in a position elevated from the tray.

2. The baking apparatus of claim 1, wherein the support members further support the basket such that the bottom surface is above the upper lip.

3. The baking apparatus of claim 1, further comprising a solid, continuous support rim coupled to the upper periphery.

4. The baking apparatus of claim 3, wherein the support members are coupled to the basket via attachment to the continuous supper rim.

5. The baking apparatus of claim 3, further comprising a first handle joined to the support rim.

6. The baking apparatus of claim 5, further comprising a second handle joined to the support rim at a point along the support rim opposite the first handle.

7. The baking apparatus of claim 1, wherein the ratio of a length of the basket to a length of the tray is between 0.91 and 0.96.

8. The baking apparatus of claim 1, wherein the ratio of a width of the basket to a width of the tray is between 0.89 and 0.95.

9. The baking apparatus of claim 1, wherein the openings represent at least 55 percent of a total area of the mesh cradle portion.

10. The baking apparatus of claim 1, wherein the openings represent approximately 76 percent of a total area of the mesh cradle portion.

11. The baking apparatus of claim 1, wherein the tray includes a channel along the base, proximate to the container wall, the channel forming a recess to: collect substances dripping off the food items; and couple with the support members to stabilize the baking apparatus.

12. The baking apparatus of claim 11, further comprising a ramp sloping between the channel and an elevated base surface of the tray, wherein the support members have angled support legs which rest along the ramp to provide additionally stability between the basket and tray.

13. The baking apparatus of claim 1, wherein the basket and tray are covered in a non-stick ceramic polish.

14. The baking apparatus of claim 1, wherein the basket and tray are made, at least in part, from a non-stick ceramic material.

15. The baking apparatus of claim 1, wherein the basket has: a width of between 218 mm and 308 mm; and a length between 298 mm and 360 mm.

16. The baking apparatus of claim 1 wherein the tray has: a width of between 240 mm and 325 mm; and a length between 320 mm and 380 mm.

17. The baking apparatus of claim 1 wherein the basket and tray are rectangular.

18. The baking apparatus of claim 1 wherein:
a width of the basket is less than a width of the tray; and
a length of the basket is less than a length of the tray.

19. A baking apparatus comprising:
a substantially rectangular baking tray having: a base; and a container wall extending upward from an outer perimeter of the base and forming an upper lip; and
a substantially rectangular basket for holding one or more food items, the basket being supported by the baking tray and having:
a mesh cradle portion having cradle members which define a plurality of openings occupying at least 55 percent of the total area of the mesh cradle portion, said mesh cradle portion having a bottom surface and a cradle wall extending upwards from the bottom surface, the cradle wall forming, at an upper end, an upper periphery;
a solid, continuous support rim coupled to the upper periphery;
a first handle joined to the support rim;
a second handle joined to the support rim at a point along the support rim opposite the first handle; and
a plurality of support members coupled to the support rim and extending downward from the support rim to a point below the bottom surface, the support members supporting the basket in a position elevated from the tray such that the bottom surface is above the upper lip,
wherein:
the tray captures substances from the one or more food items and prevents warping of the basket; and
the basket and tray allow air to circulate substantially freely around the one or more food items.

20. The baking apparatus of claim 19 wherein the tray includes a channel adjacent to the container wall, the channel forming a recess to: collect substances dripping off the food items; and couple with the support members to stabilize the baking apparatus.
